(19) United States
(12) Patent Application Publication
(10) Pub. No.: US 2009/0087704 A1
(43) Pub. Date: Apr. 2, 2009

(54) FUEL CELL UNIT AND ELECTRONIC DEVICE

(75) Inventor: Shinichi MIYAMOTO, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/237,560

(22) Filed: Sep. 25, 2008

(30) Foreign Application Priority Data
Sep. 28, 2007 (JP) 2007-255036

(51) Int. Cl. H01M 8/06; H01M 8/02

(52) U.S. Cl. 429/19; 429/26

(57) ABSTRACT

Disclosed is a fuel cell unit including a power generation cell having a first electrode and a second electrode, which generates electric power by using a first material supplied to the first electrode and a second material supplied to the second electrode, a heating unit to heat the power generation cell and a power collecting unit to take out electric power generated by the power generation cell from the first electrode or the second electrode, and the heating unit is provided at the power collecting unit.

### CROSS-REFERENCE TO RELATED APPLICATION

This application is based upon and claims the benefit of priority under 35 USC 119 of Japanese Patent Application No. 2007-255036 filed on Sep. 28, 2007, the entire disclosure of which, including the description, claims, drawings, and abstract, is incorporated herein by reference in its entirety.

### BACKGROUND OF THE INVENTION

1. Field of the Invention

The present invention relates to a fuel cell unit which takes out electricity by an electrochemical reaction between oxidant and reductant and to an electronic device which is provided with the fuel cell unit.

2. Description of the Related Art

Research and development of the fuel cell is broadly carried out as a main power system of next generation in which electricity is taken out by the electrochemical reaction between oxidant and reductant. In the solid oxide fuel cell (hereinafter called the SOFC) which is one type of the fuel cell unit, a power generation cell in which a fuel electrode is formed at one surface of the solid oxide electrolyte and an air electrode is formed at the other surface of the solid oxide electrolyte is used.

In general, the SOFC includes a cell stack in which a plurality of single cells in a plate shape or a cylindrical shape are electrically connected to one another serially or parallely by the interconnector. For example, in JP2002-75404A, the resistance element formed on the fuel electrode and the air electrode of the single cell is used as the heat source by the resistance element producing heat by itself when each single cell of the above described cell stack is being heated, and the start-up time needed until the fuel cell is in the condition where it can generate power can be shortened.

However, the resistance element for heating the single cell is formed on the air electrode with a material which has little relationship with the electrode. Therefore, the portion where the resistance element is formed within the air electrode cannot contribute to the power generation or cannot obtain the same power generation efficiency as the air electrode even if the portion could contribute to the power generation.

### SUMMARY OF THE INVENTION

A fuel cell unit of the present invention comprises a power generation cell having a first electrode and a second electrode, which generates electric power by using a first material supplied to the first electrode and a second material supplied to the second electrode, a heating unit to heat the power generation cell and a power collecting unit to take out electric power from the first electrode or the second electrode, and the heating unit is provided at the power collecting unit.

A second fuel cell unit of the present invention comprises a power generation cell having a first electrode and a second electrode, which generates electric power by using a first material supplied to the first electrode and a second material supplied to the second electrode, a heating unit to heat the power generation cell and a flow passage defining unit to define a flow passage by a surface of the flow passage defining unit between the first electrode or the second electrode and the flow passage defining unit, and the heating unit is provided at the flow passage defining unit.

A third fuel cell unit of the present invention comprises a plurality of power generation cells having a first electrode and a second electrode, which generate electric power by using a first material supplied to the first electrode and a second material supplied to the second electrode, a heating unit to heat the power generation cells, a first flow passage defining unit to define a first flow passage for the first material to flow by a surface of the first flow passage defining unit between the first electrode which is included in one power generation cell among the plurality of power generation cells and the first flow passage defining unit and a second flow passage defining unit to define a second flow passage by a surface of the second flow passage defining unit between the second electrode which is included in another power generation cell adjacent to the one power generation cell among the plurality of power generation cells and the second flow passage defining unit, and the heating unit is provided at either one of the first flow passage defining unit or the second flow passage defining unit.

An electronic device of the present invention comprises the fuel cell unit which comprises a power generation cell having a first electrode and a second electrode, which generates electric power by using a first material supplied to the first electrode and a second material supplied to the second electrode, a heating unit to heat the power generation cell and a power collecting unit to take out electric power from the first electrode or the second electrode wherein the heating unit is provided at the power collecting unit, and an electronic device main body which operates by the power generated by the fuel cell unit.

A second electronic device of the present invention comprises the fuel cell unit which comprises a power generation cell having a first electrode and a second electrode, which generates electric power by using a first material supplied to the first electrode and a second material supplied to the second electrode, a heating unit to heat the power generation cell and a flow passage defining unit to define a flow passage by a surface of the flow passage defining unit between the first electrode or the second electrode and the flow passage defining unit wherein the heating unit is provided at the flow passage defining unit, and an electronic device main body which operates by the power generated by the fuel cell unit.

A third electronic device of the present invention comprises the fuel cell unit which comprises a plurality of power generation cells having a first electrode and a second electrode, which generate electric power by using a first material supplied to the first electrode and a second material supplied to the second electrode, a heating unit to heat the power generation cells, a first flow passage defining unit to define a first flow passage for the first material to flow by a surface of the first flow passage defining unit between the first electrode which is included in one power generation cell among the plurality of power generation cells and the first flow passage defining unit and a second flow passage defining unit to define a second flow passage by a surface of the second flow passage defining unit between the second electrode which is included in another power generation cell adjacent to the one power generation cell among the plurality of power generation cells and the second flow passage defining unit wherein the heating unit is provided at either one of the first flow passage defining unit or the second flow passage defining unit, and an electronic device main body which operates by the power generated by the fuel cell unit.

### BRIEF DESCRIPTION OF THE DRAWINGS

The present invention will sufficiently be understood by the following detailed description and accompanying drawings, but they are provided for illustration only, and not for limiting the scope of the invention.

FIG. 1 is a block diagram showing a portable electronic device in which a fuel cell unit is mounted.

FIG. 2 is a schematic view of a power generation cell.

FIG. 3 is a schematic view showing an example of a cell stack.

FIG. 4 is a schematic sectional view schematically showing the cell stack.

FIG. 5 is a schematic view of a heat insulation package.

FIG. 6 is a schematic view showing an inner structure of the heat insulation package.

FIG. 7 is a plan view of a cell stack in which an electric heater is provided.

FIG. 8 is a sectional view cut along the line VIII-VIII of FIG. 7.

FIG. 9 is a sectional view cut along the line IX-IX of FIG. 7.

FIG. 10 is a plan view showing a structure of an interconnector and the electric heater.

FIG. 11 is a sectional view cut along the line XI-XI of FIG. 10.

FIG. 12 is a sectional view cut along the line XII-XII of FIG. 10.

FIG. 13 is a sectional view showing a relationship between a radiation prevention film and the electric heater.

FIG. 14 is an enlarged sectional view showing the relationship between the radiation prevention film and the electric heater.

FIG. 15 is an enlarged sectional view showing the relationship between the radiation prevention film and the electric heater.

FIG. 16 is an explanatory drawing showing a relationship between a temperature of the power generation cell according to heating and elapsed time.

FIG. 17 is a schematic sectional view schematically showing a cell stack of a modification example.

FIG. 18 is a side view showing an embodiment in which a cell tube formed in a cylindrical shape is used.

FIG. 19 is a sectional view cut along the line XVIII-XVIII of FIG. 18.

FIG. 20 is a side view of a collector electrode and the cell tube.

FIG. 21 is a side view showing a structure of the cell stack in which the cell tube is used.

### BEST MODE FOR CARRYING OUT THE INVENTION

Embodiments of the present invention will be explained with reference to the drawings.

Hereinafter, the best modes for carrying out the present invention will be described with reference to the drawings. Various types of technically preferable limitations for carrying out the present invention are added to the embodiments which will be described hereinafter. However, the scope of the invention is not limited to the following embodiments and the examples shown in the drawings.

### First Embodiment

[Electronic Device]

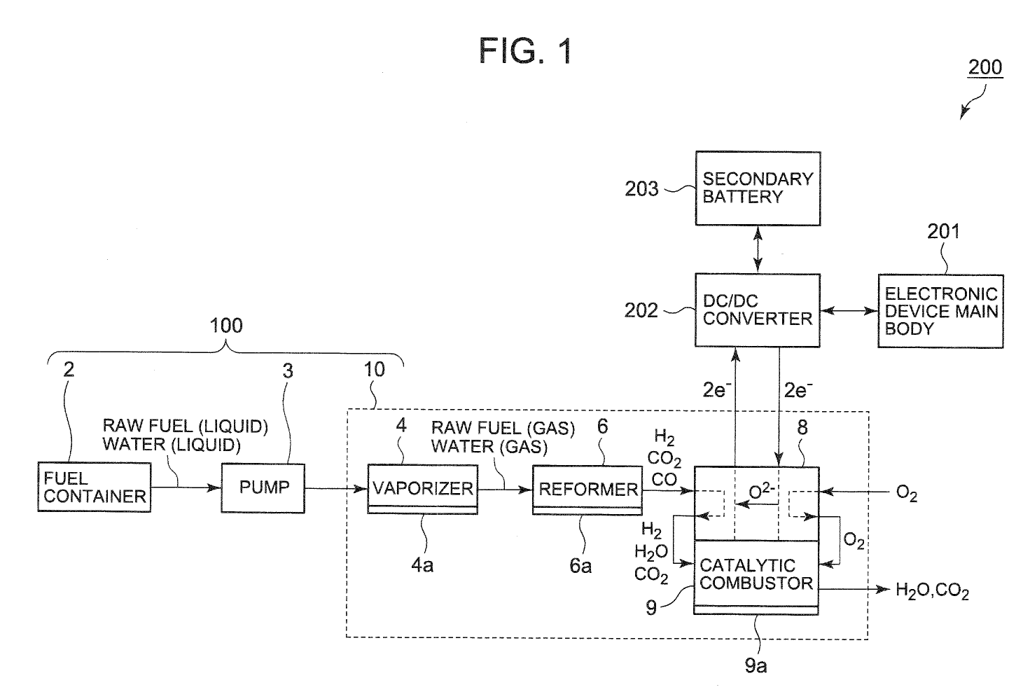

FIG. 1 is a block diagram showing a portable electronic device 200 in which a fuel cell unit 100 is mounted. For example, the electronic device 200 includes portable electronic devices such as a note-book type personal computer, the PDA, an electronic organizer, a digital camera, a cell phone, a watch, a register, a projector and the like.

The electronic device 200 comprises an electronic device main body 201, a DC/DC converter 202, a secondary battery 203, a fuel cell unit 100 and the like. The electronic device main body 201 is driven by electricity which is provided by the DC/DC converter 202 or the secondary battery 203. The DC/DC converter 202 converts the electricity generated by the fuel cell unit 100 into an appropriate voltage and supplies the voltage to the electronic device main body 201. Further, the DC/DC converter 202 charges the electricity which is generated by the fuel cell unit 100 to the secondary battery 203, and supplies the electricity which is stored in the secondary battery 203 to the electronic device main body 201 when the fuel cell unit 100 is not operating.

[Fuel Cell Unit]

The fuel cell unit 100 comprises a fuel container 2, a pump 3, a heat insulation package 10 and the like. For example, the fuel container 2 of the fuel cell unit 100 is detachably provided to the electronic device 200, and the pump 3 and the heat insulation package 10 are housed in the main body of the electronic device 200, for example.

Liquid mixture of liquid raw fuel (for example, methanol, ethanol or dimethyl ether) and water is reserved in the fuel container 2. Here, the liquid raw fuel and water may be reserved in different containers. The pump 3 aspirates the liquid mixture in the fuel container 2 and sends the liquid mixture to the vaporizer 4 in the heat insulation package 10.

The vaporizer 4, a reformer 6, a power generation cell 8 and a catalytic combustor 9 are housed in the heat insulation package 10. Air inside the heat insulation package 10 is maintained at a pressure (for example, below or equal to 10 Pa) which is lower than the atmospheric pressure. In such way, the heat conduction by air is reduced and the heat insulation function is improved. Electric heater/temperature sensors 4a, 6a and 9a are respectively provided at the vaporizer 4, the reformer 6 and the catalytic combustor 9. The electrical resistivity of the electric heater/temperature sensors 4a, 6a and 9a depend on temperature. Therefore, the electric heater/temperature sensors 4a, 6a and 9a function as temperature sensors to measure temperature of the vaporizer 4, the reformer 6 and the catalytic combustor 9, respectively.

The liquid mixture which is sent to the vaporizer 4 from the pump 3 is vaporized by being heated by the heat of the electric heater/temperature sensor 4a and the heat diffused from the catalytic combustor 9 to about 110 to 160° C. to generate gas mixture. The gas mixture generated in the vaporizer 4 is sent to the reformer 6.

A flow passage is formed inside of the reformer 6, and catalyst is carried on the wall of the flow passage. The gas mixture to be sent to the reformer 6 from the vaporizer 4 flows through the flow passage of the reformer 6 and the gas mixture is heated to about 300 to 400° C. by the heat of the electric heater/temperature sensor 6a, the reaction heat of the power generation cell 8 and the heat of the catalytic combustor 9 to cause the reforming reaction by the catalyst. The gas mixture (reformed gas) of hydrogen as a fuel, carbon dioxide, small amount of carbon monoxide which is a by-product and the like is generated by the reforming reaction of the raw fuel and water. Here, when methanol is used for the raw fuel, the steam reforming reaction as shown in the following formula (1) mainly occurs in the reformer 6.

CH₃OH+H₂O→3H₂+CO₂ (1)

Carbon monoxide is generated as a by-product in a small amount by the following formula (2) which occurs sequentially after the chemical reaction formula (1).

H₂+CO₂→H₂O+CO (2)

The gas (reformed gas) generated by the chemical reaction formulas (1) and (2) is sent to the power generation cell 8.

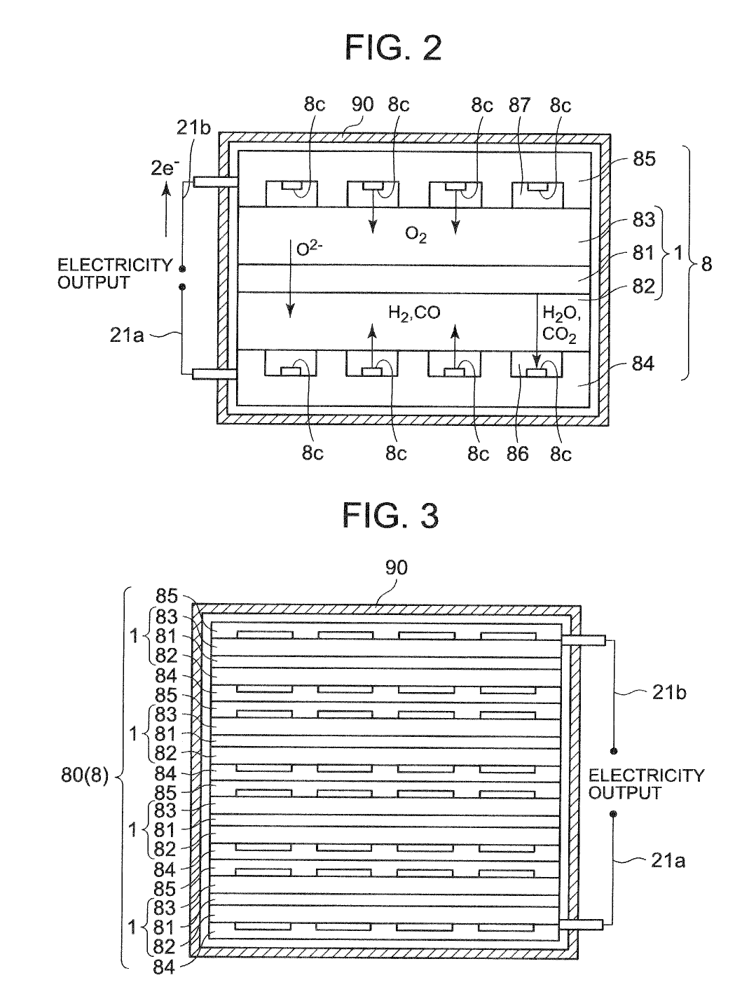

FIG. 2 is a schematic view of the power generation cell 8. As shown in FIG. 2, the power generation cell 8 comprises the solid oxide electrolyte 81, the fuel electrode 82 (second electrode, anode) and the air electrode 83 (first electrode, cathode) respectively formed on each of the sides of the solid oxide electrolyte 81, the anode collector electrode (collector unit, flow passage defining unit, second flow passage defining unit) 84 which abuts the fuel electrode 82 and in which the first flow passage 86 is formed on the abutting surface and the cathode collector electrode (collector unit, flow passage defining unit, first flow passage defining unit) 85 which abuts the air electrode 83 and in which the second flow passage 87 is formed on the abutting surface. Here, the power generation cells may be fastened to one another by using a plurality of bolts (omitted from the drawing).

Moreover, the power generation cell 8 is housed in the case 90. Here, the single cell 1 which is the standard constituent unit of battery is constituted with the solid oxide electrolyte 81 and the fuel electrode 82 and the air electrode 83 which are respectively formed on each of the sides of the solid oxide electrolyte 81 as one unit. Here, the anode collector electrode 84, the single cell 1 and the cathode collector electrode 85 are fastened closely to one another by bolts or the like (omitted from the drawing).

The power generation cell 8 is heated to about 500 to 1000° C. by the heat of the electric heater/temperature sensor 9a and the catalytic combustor 9, and each reaction shown in the following formulas (3) to (5) are caused.

Air (oxidized gas) is sent to the air electrode 83 through the second flow passage 87 of the cathode collector electrode 85. At the air electrode 83, oxygen ions are generated as shown in the following formula (3) by oxygen (first material or second material, oxidant) in air and electron supplied by the cathode output electrode 21b.

O₂+4e⁻→2O²⁻ (3)

The solid oxide electrolyte 81 has permeability to the oxygen ion, and allows the oxygen ions generated at the air electrode 83 by the chemical reaction formula (3) to reach the fuel electrode 82 by allowing the oxygen ions to pass through.

The reformed gas (fuel gas) which is discharged from the reformer 6 is sent to the fuel electrode 82 through the first flow passage 86 of the anode collector electrode 84. A reaction between the oxygen ion which passed through the solid oxide electrolyte 81 and hydrogen (second material or first material, reductant) in the reformed gas and a reaction between the oxygen ion and carbon monoxide as shown in the following formulas (4) and (5) are caused at the fuel electrode 82.

H₂+O²⁻→H₂O+2e⁻ (4)

CO+O²⁻→CO₂+2e⁻ (5)

The electrons which are released by the chemical reaction formulas (4) and (5) are supplied to the air electrode 83 by the cathode output electrode 21b via the external circuit such as the fuel electrode 82, the anode output electrode 21a, the DC/DC converter 202 and the like.

The anode output electrode 21a and the cathode output electrode 21b are respectively connected to the anode collector electrode 84 and the cathode collector electrode 85, and are pulled out by penetrating the case 90. As it is mentioned afterwards, for example, the case 90 is formed with a Ni-based alloy, and the anode output electrode 21a and the cathode output electrode 21b are pulled out so as to be insulated from the case 90 by an insulation material such as glass, ceramic or the like. As shown in FIG. 1, for example, the anode output electrode 21a and the cathode output electrode 21b are connected to the DC/DC converter 202.

The power generation cell 8 may be structured to form the cell stack 80 as shown in FIG. 3. FIG. 3 is a schematic view showing an example of the cell stack 80 which is constituted with a plurality of single cells 1, a plurality of anode collector electrodes 84 and a plurality of cathode collector electrodes 85. That is, the cell stack 80 shown in FIG. 3 is structured in a cell stack structure by serially connecting a plurality of power generation cells 8, the power generation cell 8 comprising the anode collector electrode 84, the fuel electrode 82, the solid oxide electrolyte 81, the air electrode 83 and the cathode collector electrode 85 which are shown in FIG. 2. In this case, the anode collector electrode 84 at one end of the power generation cells 8 which are serially connected is connected to the anode output electrode 21a, and the cathode collector electrode 85 at the other end of the power generation cells 8 is connected to the cathode output electrode 21b as shown in FIG. 3. Here, the cell stack 80 is housed in the case 90. A plurality of anode collector electrodes 84, a plurality of single cells 1 and a plurality of cathode collector electrodes 85 are fastened closely to one another by bolts or the like (omitted from the drawing).

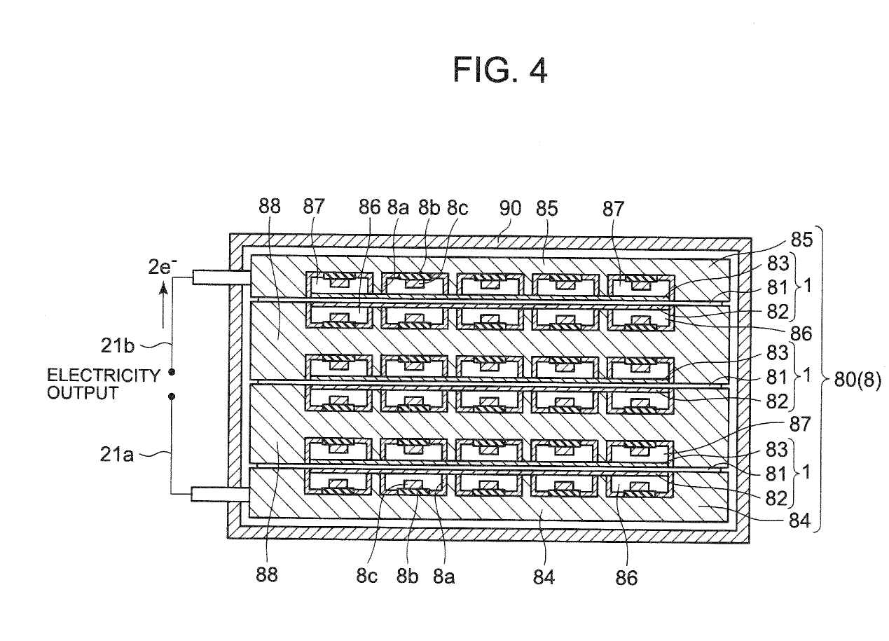

The power generation cells 8 may be structured to form the cell stack 80 as shown in FIG. 4. The cell stack 80 shown in FIG. 4 is a schematic sectional view schematically showing the cell stack 80 which has a structure in which the single cells 1 are stacked between the anode collector electrode 84 and the cathode collector electrode 85 via the interconnector (collector unit, flow passage defining unit, first flow passage defining unit and second flow passage defining unit) 88. That is, the cell stack 80 comprises a plurality of single cells 1 in which the fuel electrode 82 and the air electrode 83 are provided so as to sandwich the solid oxide electrolyte 81 and a plurality of interconnectors 88 having gas-tightness which is disposed between each of the single cells 1 to electrically connect the single cells 1. Further, the first flow passages 86 are formed on one main surface (upper side in FIG. 4) of the anode collector electrode 84 and each interconnector 88, respectively, and the second flow passages 87 are formed on the other main surface (lower side in FIG. 4) of the cathode collector electrode 85 and each interconnector 88, respectively. The interconnectors 88 has a structure in which the adjacent anode collector electrode 84 and cathode collector electrode 85 are integrally formed so as to be back to back as shown in FIG. 3. Here, the gas-tightness can be maintained between the periphery of the single cell 1, the separator 88 and the periphery of the anode collector electrode 84 or the cathode collector electrode 85 by a method such as a glass seal or the like. Other method can be used as long as the gas-tightness can be maintained.

Here, a plurality of anode collector electrode 84, a plurality of single cells 1 and a plurality of cathode collector electrodes 85 are fasted closely to one another by bolts or the like (omitted from the drawing). Further, a pair of collector plates which is different from the anode collector electrode 84 and the cathode collector electrode 85 may be disposed at both ends of the cell stack, and power may be collected by the collector plates. Further, a pair of fastening plates can be disposed at both ends of the cell stack, and the entire cell stack may be fastened via the fastening plates.

The radiation prevention film 8a and an electric heater (heating unit, resistance element) 8c which is constituted with an electric heating material for heating the power generation cell 8 are provided in the first flow passages 86 and the second flow passages 87 of the power generation cell 8 or the cell stack 80. In the example shown in FIG. 4, the radiation prevention film 8a and the insulation layer 8b are provided at the inner surface of the first flow passages 86 and the second flow passages 87, and the electric heater 8c is provided on the insulation layer 8b. Therefore, the power generation cell 8 is heated from inside by the electric heater 8c. At that time, the fuel gas and the oxidized gas which pass through the first flow passages 86 and the second flow passages 87 are also heated.

Here, the insulation layer 8b may be provided on the radiation prevention film 8a instead of being provided directly at the inner surface of the first flow passages 86 and the second flow passages 87. Further, the radiation prevention film 8a may be provided at either of the first flow passages 86 and the second flow passages 87. However, from the viewpoint of heating the entire cell stack 80 more uniformly, it is preferred to provide the electric heater at both the first flow passages 86 and the second flow passages 87 as described above. Further, the electric heater 8c can be used as the electric heater/temperature sensor which also functions as the temperature sensor by the electrical resistivity depending on the temperature.

In the reformed gas (hereinafter, the reformed gas which passed through the flow passage is called off gas) which passed through the first flow passage 86 of the anode collector electrode 84, unreacted hydrogen is also included. The off gas is supplied to the catalytic combustor 9.

Air which passed through the second flow passage 87 of the cathode collector electrode 85 is supplied to the catalytic combustor 9 along with the off gas. The flow passage is formed in the catalytic combustor 9, and a Pt-system catalyst is carried on the wall of the flow passage. The electric heater/temperature sensor 9a which is constituted with an electric heating material is provided at the catalytic combustor 9. Because the electrical resistivity of the electric heater/temperature sensor 9a depends on the temperature, the electric heater/temperature sensor 9a also functions as the temperature sensor for measuring the temperature of the catalytic combustor 9.

The gas mixture (combustion gas) of the off gas and air flows through the flow passage of the catalytic combustor 9, and the gas mixture is heated by the electric heater/temperature sensor 9a. Hydrogen within the combustion gas which is flowing through the catalytic combustor 9 is combusted by the catalyst and thereby the combustion heat is generated. The exhaust gas after the combustion is discharged outside of the heat insulation package 10 from the catalytic combustor 9.

The combustion heat which is generated in the catalytic combustor 9 is used to maintain the temperature of the power generation cell 8 at high temperature (about 500 to 1,000° C.) Then, the heat of the power generation cell 8 or the cell stack 80 is conducted to the reformer 6 and the vaporizer 4, and the heat is used for the evaporation in the vaporizer 4 and for the steam reforming reaction in the reformer 6.

### [Heat Insulation Package]

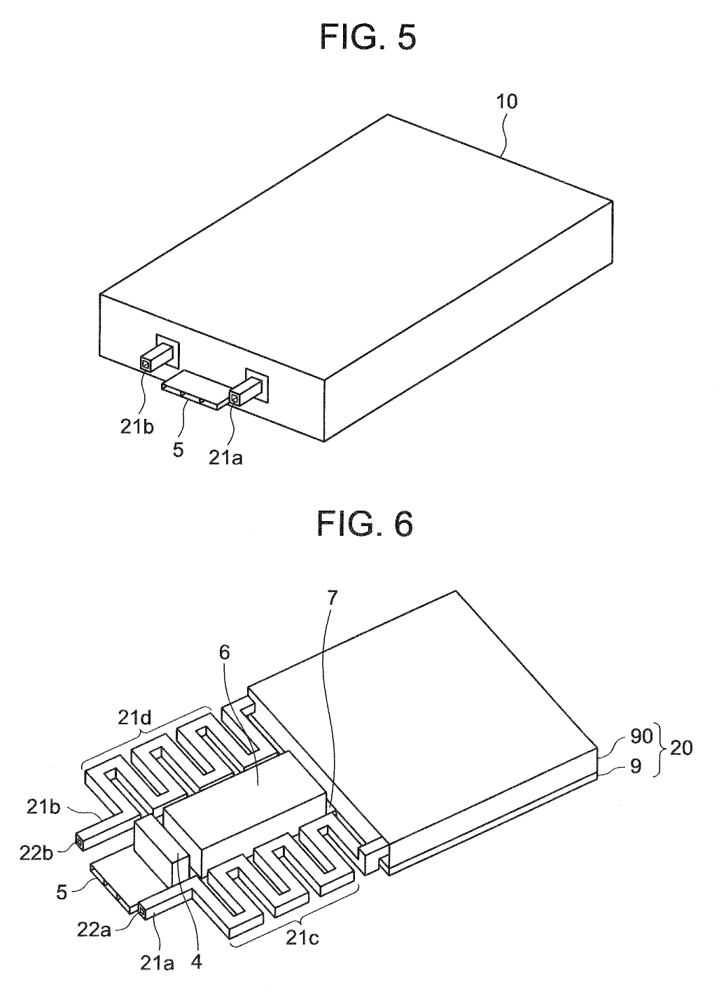

FIG. 5 is a perspective view of the heat insulation package 10, and FIG. 6 is a perspective view showing the inner structure of the heat insulation package 10. As shown in FIG. 5, a connection section 5, an anode output electrode 21a and a cathode output electrode 21b are protruded from one wall of the heat insulation package 10.

In the heat insulation package 10, the vaporizer 4, the connection section 5, the reformer 6, the connection section 7, the fuel cell unit 20 are disposed in this order. Here, the wiring pattern (omitted from the drawing) is formed on the lower surface of the connection section 5, the reformer 6, the connection section 7 and the fuel cell unit 20 after the insulation treatment is carried out thereto by the ceramic or the like. The wiring pattern is formed in a winding shape at the lower portion of the vaporizer 4, at the lower portion of the reformer 6 and at the lower portion of the fuel cell unit 20, and each wiring functions as the electric heater/temperature sensor 4a, 6a and 9a. One end of each of the electric heater/temperature sensors 4a, 6a and 9a is connected to the common terminal, and the other end of each of the electric heater/temperature sensors 4a, 6a and 9a is respectively connected to each of the three terminals which are independent from one another. The four terminals are formed at the end portion more in outside than the heat insulation package 10 of the connection section 5.

At each lower surface of the vaporizer 4, the connection section 5, the reformer 6, the connection section 7 and the fuel cell unit 20, each of the electric heater/temperature sensors 4a, 6a and 9a and their pull-out wiring are provided, respectively. Further, at the lower surface of the connection section 5 which is exposed outside of the heat insulation package 10, the ends of each pull-out wiring of each of the electric heater/temperature sensors 4a, 6a and 9a are disposed, and these ends are used as the external terminals to apply current or voltage to each of the electric heater/temperature sensors 4a, 6a and 9a. Here, the fuel cell unit 20 is constituted by the case 90 which houses the power generation cell 8 and the catalytic combustor 9 being integrally formed, and the off gas is supplied to the catalytic combustor 9 from the fuel electrode 82 of the power generation cell 8.

The vaporizer 4, the connection section 5, the reformer 6, the connection section 7, the case 90 which houses the power generation cell 8 of the fuel cell unit 20, the catalytic combustor 9, the anode output electrode 21a and the cathode output electrode 21b are formed with a metal having high temperature durability and optimum thermal conductivity, and for example, they can be formed by using the Ni-based alloy such as the inconel 783. Furthermore, in order to reduce the stress which occurs between the vaporizer 4, the connection section 5, the reformer 6, the connection section 7, the case 90 of the fuel cell unit 20 and the catalytic combustor 9 as the temperature increases, it is preferred to form all the above with the same material.

At the inner wall surface of the heat insulation package 10, the radiation prevention film (omitted from the drawing) is provided. Also, at the outer wall surface of the vaporizer 4, the connection section 5, the reformer 6, the connection section 7, the anode output electrode 21a, the cathode output electrode 21b and the fuel cell unit 20, the radiation prevention film (omitted from the drawing) is formed. The radiation prevention film is for preventing the heat conduction by the radiation, and for example, Au or the like can be used for the radiation prevention film. It is preferred to provide either one of the above radiation prevention films at the inner wall surface of the heat insulation package 10 and at the outer wall surface of the vaporizer 4, the connection section 5, the reformer 6, the connection section 7, the anode output electrode 21a, the cathode output electrode 21b and the fuel cell unit 20, and it is more preferred to provide both of the above radiation prevention films.

Here, in order to make the flow passage diameter of the exhaust gas which is exhausted from the catalytic combustor 9 be efficiently large with respect to the flow passage diameter of the off gas and air to be supplied to the catalytic combustor 9, two flow passages among three flow passages which are provided in the connection section 7 are used as the flow passage for the exhaust gas which exhausts from the catalytic combustor 9 and another one flow passage is used as the flow passage for supplying the reformed gas to the fuel electrode 82 of the power generation cell 8.

As shown in FIGS. 5 and 6, the anode output electrode 21a and the cathode output electrode 21b have the folding sections 21c and 21d, respectively, which are folded in the space between the inner wall surface of the heat insulation package 10 and the fuel cell unit 20. The folding sections 21c and 21d function so as to moderate the stress which acts on between the fuel cell unit 20 and the heat insulation package 10 due to the deformation of the anode output electrode 21a and the cathode output electrode 21b by the thermal expansion. The anode output electrode 21a and the cathode output electrode 21b are formed in a hollow tube shape, and insides thereof are used as the air supply flow passages 22a and 22b which supply air to the oxygen electrode 83 of the power generation cell 8.

Regarding the temperature distribution in the heat insulation package 10 at the time of steady operation, the heat insulation package 10 is heated by applying current or voltage to the electric heater/temperature sensor 4a, 6a and 9a, and at the same time, heat moves to the reformer 6 from the fuel cell unit 20 via the connection section 7, then to the vaporizer 4 and to outside of the heat insulation package 10 from the reformer 6 via the connection section 5 when the fuel cell unit 20 is maintained at about 800° C., for example. As a result, the reformer 6 is maintained at about 380° C. and the vaporizer 4 is maintained at about 150° C. Here, the power generation cell 8 is normally constituted as the cell stack 80 which includes a plurality of single cells 1. Therefore, the cell stack 80 of FIG. 4 will be explained as an example in the following description.

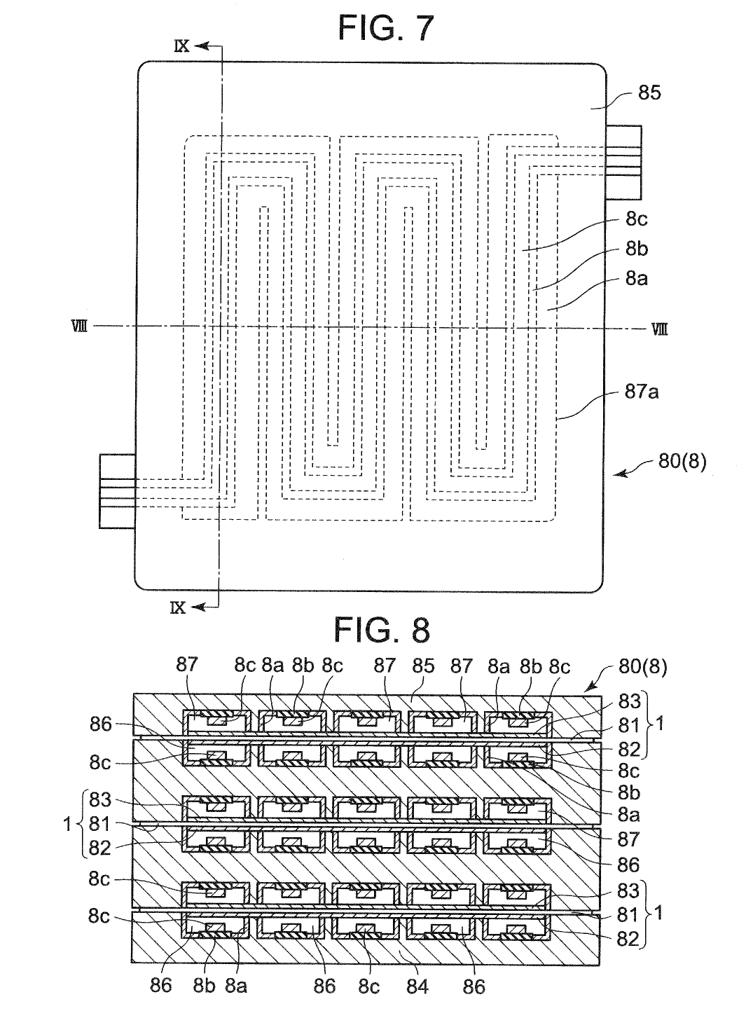

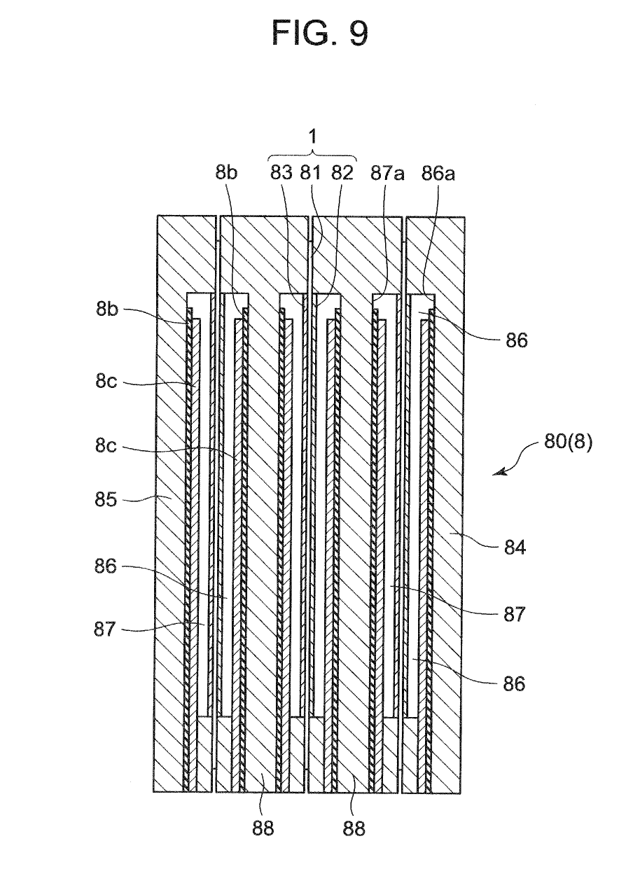

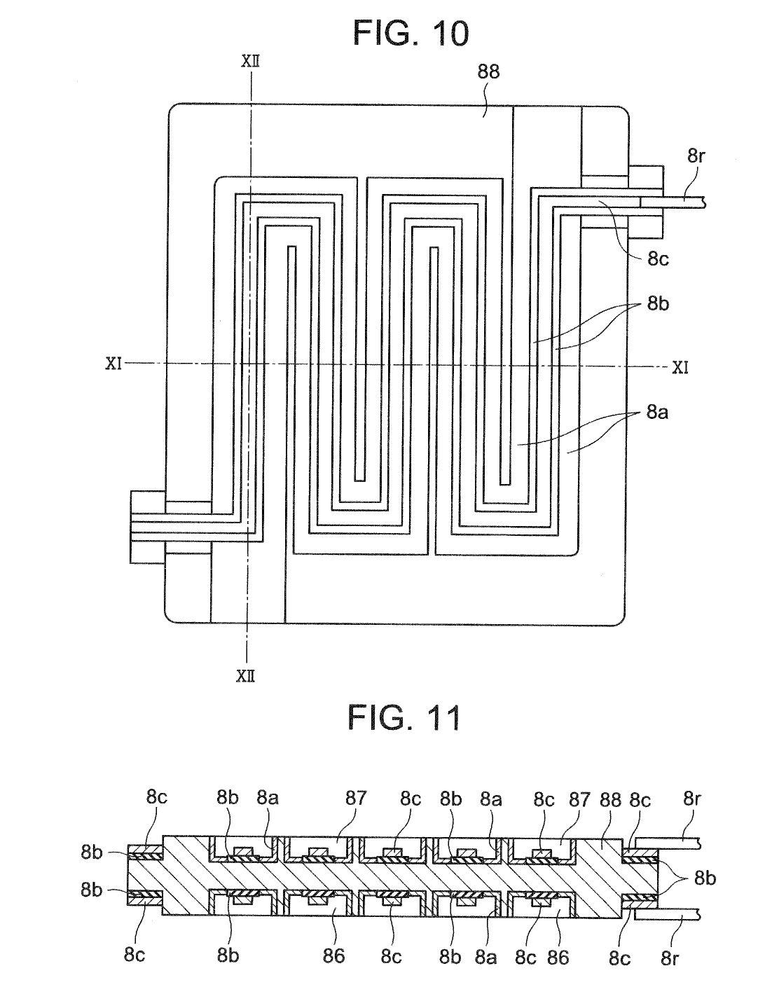

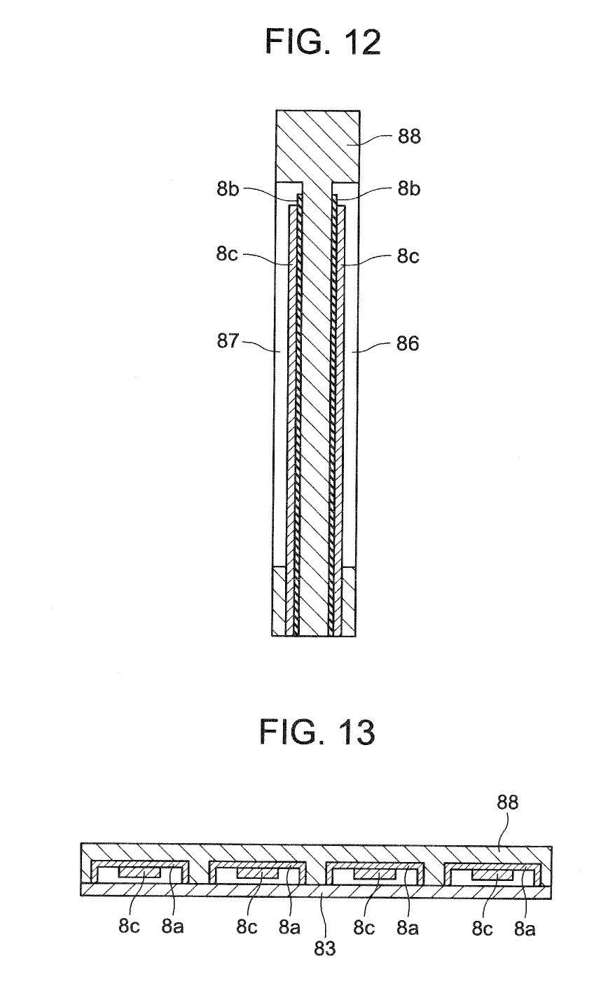

FIG. 7 is a plan view of the cell stack 80 in which the electric heater 8c is provided, FIG. 8 is a sectional view cut along the line VIII-VIII of FIG. 7 and FIG. 9 is a sectional view cut along the line IX-IX of FIG. 7. Further, FIG. 10 is a plan view showing the structure of the interconnector 88 and the electric heater 8c, FIG. 11 is a sectional view cut along the line XI-XI of FIG. 10 and FIG. 12 is a sectional view cut along the line XII-XII of FIG. 10.

As shown in FIG. 4 and FIGS. 7 to 12, the interconnector 88 of the cell stack 80 is a member having gas-tightness for electrically connecting between the single cells 1, and grooves 86a and 87a (see FIG. 9) are formed on a surface of the interconnector 88 which contacts with the fuel electrode 82 and the air electrode 83. In such way, the first flow passage 86 for supplying the fuel gas is formed between the groove 86a and the fuel electrode 82 and the second flow passage 87 for supplying air is formed between the groove 87a and the air electrode 83.

In the embodiment, the radiation prevention film 8 and the insulation layer 8b are provided at the inner surface of the grooves 86a and 87a which are formed at the interconnector 88 in a winding shape, and the electric heater 8c is provided on the insulation layer 8b. As shown in FIG. 7, the electric heater 8c is pulled outside of the flow passage at near the entrance and at near the exit of each of the flow passages 86 and 87, and is connected to the lead wires 8r and 8r at outside. Then, these lead wires 8r and 8r are routed outside of the heat insulation package 10. Here, a concave portion is formed at the pulled out section of the electric heater 8c at the outer periphery portion of the interconnector 88, and the concave portion is sealed by a glass seal or the like to maintain the gas-tightness after the electric heater 8c is formed at the concave portion. In this case, it is preferred that the concave portion is filled with the same material as the interconnector 88. Further, a lid material which engages with the concave portion may be fitted and the portion (parting line) where the concave portion and the lid material contact one another may be sealed by a glass seal.

The air electrode 83 of the cell stack 80 is not particularly limited, and a known air electrode material, for example, (La₁₋ₓSrₓMnO₃), (La₁₋ₓCoₓO₃), (La₁₋ₓSrₓFe_{1-y}Co_{y}O₃) or the like may be selected. The fuel electrode 82 of the cell stack 80 is also not particularly limited, and a known fuel electrode material, for example, (Ni/YSZ), (La₁₋ₓSrₓCr_{1-y}Co_{y}O₃) or the like may be selected. The solid oxide electrolyte 81 is also not particularly limited, and a known material, for example, a zirconia electrolyte, a ceria-based electrolyte, a lanthanum gallate electrolyte or the like may be selected.

The forms of the fuel electrode 82 and the air electrode 83 are not particularly limited as long as the oxidized gas and the fuel gas can be diffused. However, it is preferred that the electrodes having a porous structure are used for the fuel electrode 82 and the air electrode 83. The form of the solid oxide electrolyte 81 is not particularly limited as long as it is compactly structure, and the form may be any one of a sintered object (polycrystal substance), a monocrystal and a thin film or a combination of these. Further, a material different from the electrode such as a reaction inhibition layer or the like may be inserted in the interface of the air electrode 83 and the solid oxide electrolyte 81 and in the interface of the fuel electrode 82 and the solid oxide electrolyte 81.

The interconnector 88 which electrically connects the single cells 1 and which is for making the fuel gas and air flow to the fuel electrode 82 and the air electrode 83, respectively, is also not particularly limited, and a known material, for example, a lanthanum chromite, a nickel-based alloy, a ferritic alloy, a chromium alloy, a titanate or the like can be selected.

The form of the first flow passage 86 and the second flow passage 87 formed at the interconnector 88 is also not particularly limited, and a serpentine flow passage, a parallel flow passage, an approximately rectangular shape flow passage which is a passage formed by only forming a groove on the entire surface or the like can be selected.

The electric heater 8c which is constituted with the resistance element and which is provided in the first flow passage 86 and the second flow passage 87 may be formed on the entire surface of the groove with respect to the width of the flow passage or may be formed at a portion thereof. The material of the electric heater 8c is not particularly limited, and the material such as a ceramic or a PT, a tungsten, Au or the like can be selected. It is preferred to select a tungsten for the fuel electrode 82. The electric heater 8c may be formed by applying a paste which includes a material suitable for the electric heater or may be formed by using a sputter or the like.

The thickness of the electric heater 8c is not particularly limited as long as the thickness is thinner than the depth of the first flow passage 86 and the second flow passage 87 and as long as the electric heater 8c does not block the flow of air and fuel gas and it does not break by the applied voltage or current. Moreover, the radiation prevention film 8a to be formed in each flow passage is for efficiently using the radiation heat of the electric heater 8c and is formed along with the electric heater 8c.

The radiation prevention film 8a can be formed by applying a paste or may be formed by using a sputter or the like. The thickness of the radiation prevention film 8a is not limited as long as the thickness is thinner than the depth of the flow passage and the radiation prevention film 8a does not block the flow of gas. Further, as long as the thickness is efficient to reflect the radiation heat. Moreover, the radiation prevention film 8a may be formed in a single layer. However, a plurality of layers of radiation prevention film 8a may be layered in a stacking manner. From the viewpoint of the reflecting property of the radiation heat and the processability, it is particularly preferable that the radiation prevention film 8a is formed with Au.

Moreover, the insulation layer 8b is provided at the contact surface between the interconnector 88 and the radiation prevention film 8a and at the contact surface between the interconnector 88 and the electric heater 8c. A material used for the insulation layer 8b is not particularly limited as long as the insulation layer 8b has a higher resitivity than the electric heater 8c and as long as the material can electrically insulate the electric heater 8c and the radiation prevention film 8a. For example, SiO₂, alumina or the like can be used for the insulation layer 8b. The insulation layer 8b may be formed by the sputtering method or the like, or may be applied by forming the material in a paste form. The insulation layer 8b may be formed in a single layer. However, the insulation layer 8b may be formed by layering a plurality of films in a stacking manner. By providing the insulation layer 8b, the electric heater 8c can be provided in a manner so as not to influence the function of the radiation prevention film 8a.

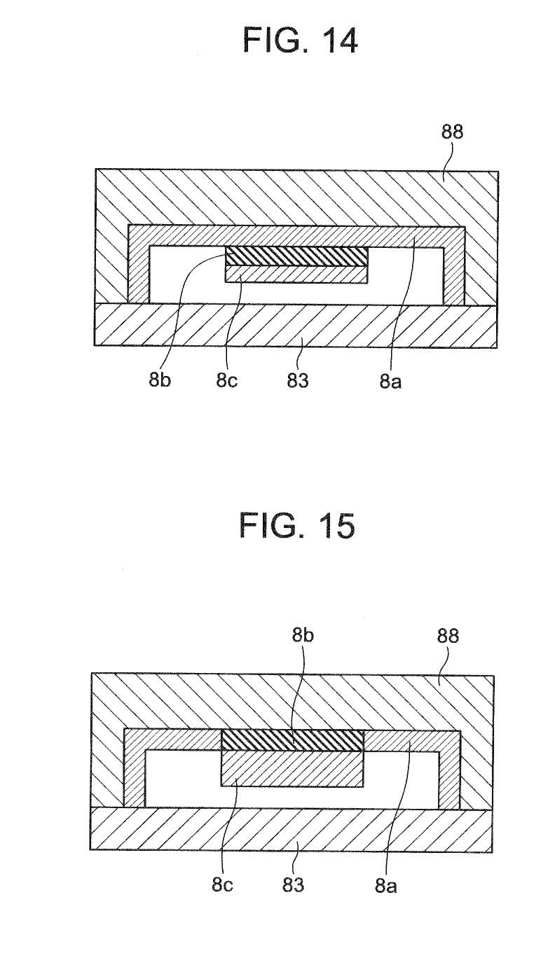

FIG. 13 is a sectional view showing the relationship between the radiation prevention film and the electric heater, and FIG. 14 and FIG. 15 are enlarged sectional views showing the relationship between the radiation prevention film and the electric heater. Here, in FIG. 13, the insulation film is omitted for convenience. As for the order of forming the electric heater 8c and the radiation prevention film 8a, for example, the insulation film 8b and the electric heater 8c may be formed on the radiation prevention film 8a after forming the radiation prevention film 8a as shown in FIG. 14, or the radiation prevention film 8a may be formed at a portion of the flow passage where the electric heater 8c is not formed after the insulation film 8b and the electric heater 8c are formed as shown in FIG. 15.

The cell stack 80 is housed in the heat insulation package 10. However, an external heater H as described in FIG. 21 is not provided to the heat insulation package 10. The inner wall of the heat insulation package 10 may be left as it is in the state of the constituent material. However, it is preferred that the radiation prevention film is formed on the inner wall.

Here, the cell stack 80 which is shown in FIG. 21 for comparison also has a structure which is basically same as FIG. 8 where the single cells 1 are stacked between the anode collector electrode 84 and the cathode collector electrode 85 via the interconnector 88. The single cell 1 also has a structure in which the fuel electrode 82 and the air electrode 83 are provided so as to sandwiching the solid oxide electrolyte 81, and the interconnector 88 for electrically connecting the single cells 1 is disposed between each of the single cells 1. The grooves 86a and 87a for forming the flow passages 86 and 87 are formed at the anode collector electrode 84, the cathode collector electrode 85 and the interconnector 88, respectively. The external heater H for heating the cell stack 80 is disposed outside of the cell stack 80.

Temperature of the cell stack 80 is increased (heated) by applying current or voltage to the electric heater 8c which is formed in the above interconnector 88. Differently from the method described in FIG. 21, the temperature can increase by maintaining the temperature in the cell stack 80 so as to be approximately uniform because the cell stack 80 is heated from inside thereof by the electric heater 8c which is provided at the interconnector 88 and not by heating from outside of the cell stack 80 by using the external heater H. Therefore, the heat stress can be suppressed at the minimum and the temperature rising rate can be speeded up. As a result, the heating time to heat the cell stack 80 so that the entire cell stack 80 reaches the temperature which allows the power generation is shortened, and the high-speed startup can be carried out. This is same for the power generation cell 8 which has one single cell 1 shown in FIG. 2. The power generation cell 8 is heated from inside thereof by the electric heater 8c which is provided in the flow passage of the anode collector electrode 84 and the cathode collector electrode 85. In such way, the heating time to heat the power generation cell 8 so that the entire power generation cell 8 reaches the temperature which allows the power generation is shortened and the high-speed startup can be carried out.

Moreover, the electric heater is not provided on the fuel electrode and the air electrode (electrode) as in the prior art described in Patent Document 1 because the electric heater is provided in the flow passage on the wall surface of the groove which forms the flow passage. Therefore, the power generation efficiency of the power generation cell 8 or the cell stack 80 is not reduced, and also, the reduction of the power generation efficiency due to the electric heater and the electrode reacting with one another is suppressed. Here, the oxidized gas and the fuel gas may flow into each of the flow passages 86 and 87 before the cell stack 80 is heated or they may flow into each of the flow passages 86 and 87 after the cell stack 80 reached the temperature which allows the power generation. Further, the oxidized gas and the fuel gas may flow into each of the flow passages 86 and 87 while the cell stack 80 is being heated.

As described above, a portion of the inner surface of the first flow passage 86 and the second flow passage 87 is formed by the interconnector 88, and the electric heater 8c is provided at the grooves 86a and 87a which are formed at the surface of the interconnector 88. Therefore, the power generation efficiency of the cell stack 80 is not reduced due to the electric heater 8c covering the surface of the electrodes of the fuel electrode, the air electrode and the like. Further, reduction of the power generation efficiency due to the electric heater and the electrodes reacting with one another is suppressed.

Moreover, as described above, the radiation prevention film 8a is provided at both of the inner surface of the second flow passage 87 and the inner surface of the first flow passage 86. Therefore, the temperature of the cell stack 80 can increase efficiently by maintaining the temperature inside of the cell stack 80 so as to be approximately uniform. It is needless to say that the function of the radiation prevention film 8a can be efficiently performed even when the radiation prevention film 8a is provided at either one of the inner surface of the first flow passage 86 and the inner surface of the second flow passage 87.

The single cell 1 of the embodiment is formed in a plate shape in which the fuel electrode 82 is formed on one side of the solid oxide electrolyte 81 which is formed in a film form and in which the air electrode 83 is formed on the other side of the solid oxide electrolyte 81, and the plate shape single cells 1 are stacked in a multiple layers via the interconnector 88. In such way, the power generation cell 8 or the cell stack 80 in a plate shape in which the temperature can increase approximately uniformly from inside thereof can be obtained.

### EMBODIMENT

Structure of the cell stack: The single cell 1 is structured as the structure shown in FIGS. 4 to 9. The La_{0.8}Sr_{0.2}MnO₃ (LSM) is used for the air electrode 83 and the 8YSZ in a plate shape is used for the solid electrolyte 81. The calcinations is carried out to the 8YSZ at a predetermined temperature. The coating liquid in which the above LSM is diffused is applied on the 8YSZ by the spin coat method and is calcinated at a predetermined temperature to form the air electrode 83. Next, the coating liquid in which the Ni/8YSZ is diffused is applied by the doctor blade method to the back side of the 8YSZ electrolyte which formed the air electrode 83 and is calcinated at a predetermined temperature to manufacture the single cell 1.

The interconnector 88 for electrically connecting between the fuel electrode 82 and the air electrode 83 of the adjacent single cells 1 is sandwiched between each of the single cells 1. The material used for the interconnector 88 is the inconel 600, and the first flow passage 86 and the second flow passage 87 which allow the fuel gas and the oxidized gas to flow into each electrode are formed on the surfaces of the interconnector 88 which contact with the fuel electrode 82 and the air electrode 83.

In the first flow passage 86 and the second flow passage 87, the radiation prevention film 8a is formed with Au which has a good resistivity, a good radiation prevention effect and the like by the sputtering method. Further, the insulation layer 8b is formed on the radiation prevention film 8a by the coating robot so as to make the radiation prevention film 8a be insulated after the radiation prevention film 8a is formed. The SiO₂ is used for the insulation layer 8b.

The Pt is made in a paste form, and the electric heater 8c is formed in the first flow passage 86 and in the second flow passage 87 by using the coating robot and is calcinated at a predetermined temperature. Three stacks of the single cell 1 are stacked by sandwiching the interconnector 88 to form the cell stack 80. The cell stack 80 is put into a container manufactured by the SUS, and the container is sealed after taking out the gas supply port and the outlet which correspond with the above air supply flow passages 22a and 22b, the electrodes for heaters which correspond to the pull-out wiring of the electric heater/temperature sensors 4a, 6a and 9a and the cell stack output terminals which correspond to the anode output electrode 21a and the cathode output electrode 21b.

(Evaluation)

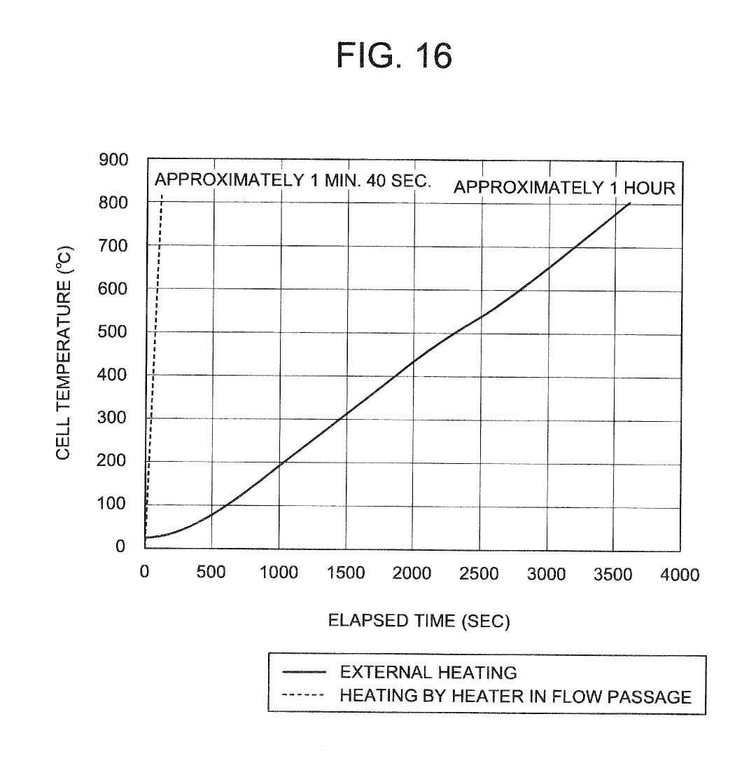

As for evaluation, voltage is applied to the above described electric heater 8c, and the time needed to reach the temperature which allows the power generation (800° C. for this time) is measured by monitoring the temperature by the thermometer (the R-type thermocouple) which is set in the cell stack 80. The time needed to reach 800° C. is shown in FIG. 16. After the evaluation, the cell stack 80 is cooled down to the room temperature by using few dozens of hours and it is confirmed whether the cell stack 80 including the single cell 1 is impaired or not. Impairment and the like were not found (see table 1)

TABLE 1

| Example | Impairment is found or not |
|---|---|
| Embodiment | No |
| Comparison example 1 | No |
| Comparison example 2 | Crack |

### Comparison Example 1

The cell stack structure: the structure of the cell stack 80 is same as that described in the first embodiment. However, as shown in FIG. 21, the electric heater 8c and the radiation prevention film 8a are not formed in the flow passage of the interconnector 88. The cell stack 80 is put into the heating furnace which comprises the external heating heater H, and the heating furnace is made to be in a nearly sealed condition after taking out the gas supply port and the outlet which correspond to the above described air supply flow passages 22a and 22b, the electrodes for heaters which correspond to the pull-out wirings of the electric heater/temperature sensors 4a, 6a and 9a and the cell stack output terminals which correspond to the anode output electrode 21a and the cathode output electrode 21b.

(Evaluation)

As for evaluation, the heat quantity same as the embodiment is applied to the external heating furnace, and the time needed for the cell stack 80 to reach the temperature which allows the power generation (800° C. for this time) is measured by monitoring the temperature by the thermometer which is set in the cell stack 80. The time needed to reach 800° C. is shown in FIG. 16. After the evaluation, the cell stack 80 is cooled down to the room temperature by using few dozens of hours and it is confirmed whether the cell stack 80 including the single cell 1 is impaired or not. Impairment and the like were not found (see table 1).

Here, FIG. 16 is a graph showing the relationship between the heating time and the temperature in the cell stack 80 of the embodiment 1 and the comparison example 1. From this drawing, it is clear that the temperature in the embodiment reaches the temperature which allows the power generation faster than the temperature in the comparison example. Therefore, the start-up time can be shortened.

### Comparison Example 2

The heat quantity of the external heating furnace is changed so that the rate of temperature increase is the same as that of the embodiment in FIG. 16 in the same structure as the structure of the comparison example 1, and it is confirmed whether an impairment and the like of the cell stack 80 exist or not. The cell stack 80 is cooled down to a room temperature by using few dozens of hours and it is confirmed whether the cell stack 80 and the single cell 1 are impaired or not. Impairment was found in the single cell 1 (see table 1).

In the comparison example 2, it is considered that because the rate of temperature increase is too fast, the temperature in the cell stack 80 did not increase uniformly causing the heat stress to occur, and the impairment occurred. From the above, in the embodiment, the temperature can increase to the temperature which allows the power generation in short time without impairing the cell stack 80 or the power generation cell 8 including the single cells 1, and the fuel cell can be started up in a short time.

According to the embodiment, the heating time needed when heating the power generation cell 8 or the cell stack 80 to the temperature which allows the power generation can be shortened by heating the power generation cell 8 or the cell stack 80 by the electric heater 8c formed in each of the flow passages 86 and 87 of the interconnector 88. Further, the start-up time can be shortened. Moreover, by having the structure as described above, the temperature can increase while maintaining the temperature distribution of the cell stack 80 so as to be approximately uniform even when the cell stack 80 is heated rapidly, and the occurrence of the heat stress in the power generation cell 8 or the cell stack 80 can be suppressed. Further, the impairment in the power generation cell 8 or the cell stack 80 can be prevented even when the temperature of the power generation cell 8 or the cell stack 80 is increased rapidly.

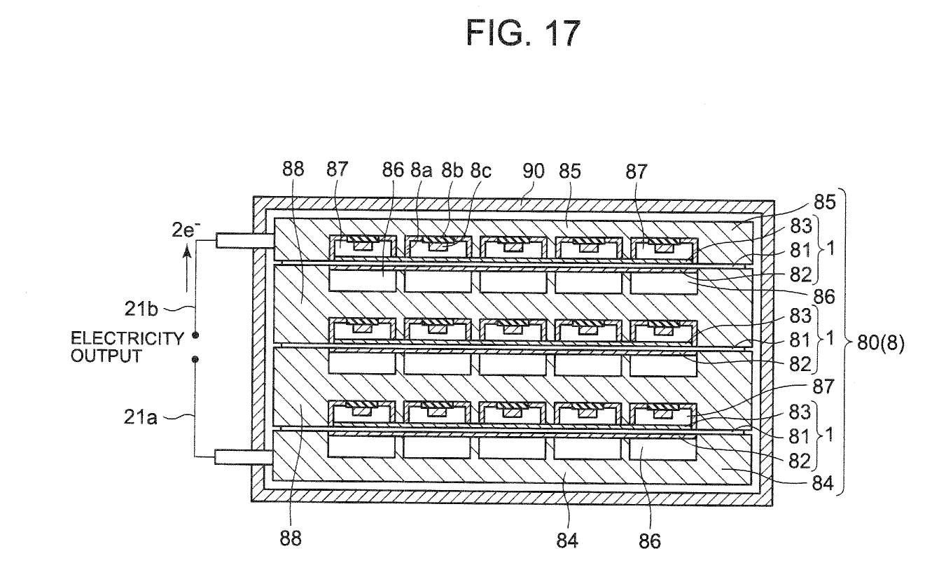

In the embodiment, the electric heater 8c is provided at each of the flow passages 86 and 87 of the cathode collector electrode 85, the anode collector electrode 84 and the interconnector 88. However, as shown in the modification example shown in FIG. 17, the electric heater 8c may be provided at either one of the flow passages 86 and 87. In such case, the radiation prevention film 8a and the insulation film 8b do not need to be provided at the flow passage in which the electric heater 8c is not provided.

### Second Embodiment

Hereinafter, the fuel cell unit according to another embodiment will be described. However, it is needless to say that the fuel cell unit of this embodiment which will be described afterwards can be applied to the same electronic device and the heat insulation package as the abode described first embodiment.

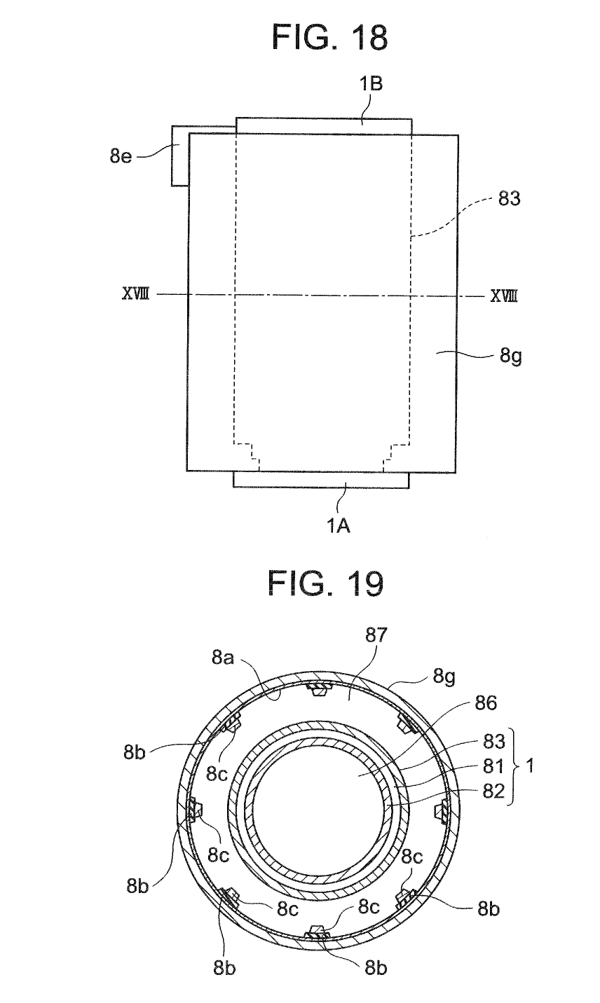

In the first embodiment, the fuel cell is structured in a plate shape. However, the present invention is also applicable to the fuel cell in a cylinder shape. The structure in case of the cylindrical power generation cell is shown in FIGS. 17 and 18. FIG. 17 is a side view showing the embodiment in which a cylindrical cell tube is used, and FIG. 18 is a sectional view cut along the line XVIII-XVIII in FIG. 17.

The power generation cell 8 of the second embodiment comprises a cylindrical single cell (hereinafter called a cell tube) 1 in which the fuel electrode 82 is provided on the inner surface of the solid oxide electrolyte 81 which is formed in a cylindrical shape and in which the air electrode 83 is provided on the outer surface of the solid oxide electrode 81, the cylindrical guide 8g which is disposed so as to encircle outside of the cell tube 1 and the electric heater (heating unit, resistance element) 8c to heat the cell tube 1 which is provided on the inner surface of the cylindrical guide 8g via the insulation layer 8b. Further, the cylindrical guide 8g is connected to either one of the electrodes of the single cell via the connection tab. In such case, the cylindrical guide 8g is connected to the fuel electrode 82 via the connection tab 8d or is connected to the air electrode 83 via the connection tab 8e. FIG. 17 is a diagram showing a case where the cylindrical guide 8g is connected to the air electrode 83 via the connection tab 8e.

In the second embodiment, the first flow passage 86 is formed at the inner periphery surface of the fuel electrode 82, the second flow passage 87 is formed by the inner periphery surface of the cylindrical guide (collector unit, flow passage defining unit, first flow passage defining unit) 8g and the outside periphery surface of the air electrode 83, and the electric heater 8c is provided in the second flow passage 87. In the embodiment, the radiation prevention film 8a is provided on the inner periphery surface of the cylindrical guide 8g, the insulation layer 8b is provided on the radiation prevention film 8a, and the electric heater 8c is provided on the insulation layer 8b. Here, the electric heater 8c, the radiation prevention film 8a and the insulation layer 8b of the second embodiment are structured with the material similar as the material used in the above described embodiment. However, they may be structured with other materials.

FIG. 19 is a side view of the collector electrode and the cell tube. As shown in FIG. 19, the anode collector electrode 1A and the cathode collector electrode 1B for taking the collected power from the fuel electrode 82 and the air electrode 83 are respectively attached at both ends of the cell tube 1 formed in a cylindrical shape.

As shown in FIGS. 17 to 20, the cylindrical guide 8g which also functions as the interconnector is disposed at the outer periphery of the above described cylindrical shaped cell tube 1 so as to form a space (second flow passage 87) for the oxidized gas such as air to flow. The cylindrical guide 8a which also functions as the interconnector is formed with a material such as a metal having conductivity or the like, and the cylindrical guide 8g which also functions as the interconnector is electrically connected with the anode collector electrode 1A or the cathode collector elector 1B by the connection tab 8d or the connection tab 8e, respectively. Further, the radiation prevention film 8a is formed at the inner surface of the cylindrical guide 8g which also functions as the interconnector, and furthermore, the insulation layer 8b is formed and the electric heater 8c is formed on the insulation layer 8b.

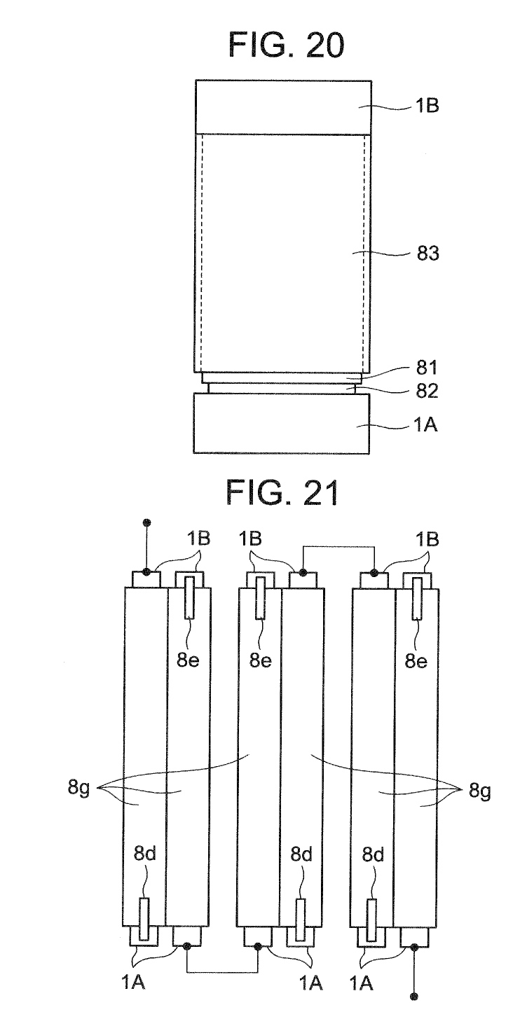

FIG. 20 is a side view showing the structure of the cell stack 80 which uses the cell tube in which the power generation cell 8 of FIG. 17 is modulized. Each of the cylindrical guide 8g which also functions as the interconnector are electrically connected with the anode collector electrode 1A or the cathode collector electrode 1B which are disposed inside of the cylindrical guide 8g and with the connection tab 8d or the connection tab 8e, respectively, by a desired wiring. In such way, the adjacent cell tubes 1 are electrically connected via the cylindrical guide 8g which also functions as the interconnector. Here, FIG. 21 is a diagram showing a case where a plurality of power generation cell 8 is electrically serially connected.

According to the second embodiment, the electric heater 8c is provided on the inner periphery surface of the cylindrical guide 8g which also functions as the interconnector, and the heating time needed when heating the cell stack 80 to the temperature which allows the power generation can be shortened similarly to the above described first embodiment by applying current or voltage to the electric heater 8c to heat the cell stack 80 from inside of the second flow passage 87. Further, the start-up time can be shortened. Moreover, by having the structure as described above, the temperature can increase while maintaining the temperature distribution in the cell stack 80 so as to be approximately uniform even when the cell stack 80 is heated rapidly, and the occurrence of the heat stress in the cell stack 80 and the cell tube 1 can be suppressed. Further, impairment in the cell stack 80 and the cell tube 1 can be prevented even when the temperature is increased rapidly.

Moreover, the electric heater 8c is provided in the second flow passage 87 which is disposed between the cell tube 1 and the cylindrical guide 8g. Therefore, similarly to the first embodiment, the power generation efficiency of the cell stack 80 is prevented from being reduced due to the electric heater 8c covering the surfaces of the fuel electrode 82 and the air electrode 83, and further, the power generation efficiency is prevented from being reduced due to the electric heater 8c and each electrode reacting with one another. Further, in such way, the power generation cell 8 can be heated from inside thereof while the power generation efficiency is prevented from being reduced. Therefore, the heating time needed to heat the cell stack 80 to the temperature which allows the power generation can be shortened, and further, the start-up time can be shortened.

Moreover, the radiation prevention film 8a is provided at the inner surface of the second flow passage 87. Therefore, the temperature can be efficiently increased while maintaining the temperature in the power generation cell 8 or the cell stack 80 so as to be approximately uniform.

Here, in the above described second embodiment, an example in which the inner surface side of the cell tube 1 is used as the first flow passage 86 for the fuel gas and the outer surface side thereof is used as the second flow passage 87 for the oxidized gas is described. However, the inner surface side of the cell tube 1 may be used as the second flow passage 87 for the oxidized gas and the outer surface side thereof may be used as the first flow passage 86 for the fuel gas. Further, it is described that the connection tab 8d and the connection tab 8e are structured differently from the cylindrical guide 8g which also functions as the interconnector. However, the structure of the connection tab 8d and the connection tab 8e is not limited to this, and the connection tab 8d and the connection tab 8e can be structured so as to be included in the cylindrical guide 8g which also functions as the interconnector because they are structured for maintaining the electrical connection.

Furthermore, in the above described embodiment, the description is given for an example in which the present invention is applied to the solid oxide fuel cell unit. However, the present invention my be applied to the fuel cell units of other forms such as the solid polymer fuel cell unit, the molten carbonate type fuel cell unit and the like.

What is claimed it:

1. A fuel cell unit, comprising:
a power generation cell having a first electrode and a second electrode, which generates electric power by using a first material supplied to the first electrode and a second material supplied to the second electrode;
a heating unit to heat the power generation cell; and
a power collecting unit to take out electric power from the first electrode or the second electrode; wherein
the heating unit is provided at the power collecting unit.

2. The fuel cell unit according to claim 1, wherein the power collecting unit takes out electric power generated by the power generation cell from the first electrode and the second electrode.

3. The fuel cell unit according to claim 1, comprising a plurality of the power generation cell, wherein
the plurality of power generation cells are electrically connected to each other by the power collecting unit.

4. The fuel cell unit according to claim 1, wherein the power collecting unit defines a flow passage for the first material or the second material to flow by a surface of the power collecting unit between the power collecting unit and the first electrode or the second electrode.

5. The fuel cell unit according to claim 4, wherein the heating unit is provided in the flow passage.

6. A fuel cell unit, comprising:
a power generation cell having a first electrode and a second electrode, which generates electric power by using a first material supplied to the first electrode and a second material supplied to the second electrode;
a heating unit to heat the power generation cell; and
a flow passage defining unit to define a flow passage by a surface of the flow passage defining unit between the first electrode or the second electrode and the flow passage defining unit, wherein
the heating unit is provided at the flow passage defining unit.

7. The fuel cell according to claim 6, wherein the heating unit is provided in the flow passage.

8. A fuel cell unit, comprising:
a plurality of power generation cells having a first electrode and a second electrode, which generate electric power by using a first material supplied to the first electrode and a second material supplied to the second electrode;
a heating unit to heat the power generation cells;
a first flow passage defining unit to define a first flow passage for the first material to flow by a surface of the first flow passage defining unit between the first electrode which is included in one power generation cell among the plurality of power generation cells and the first flow passage defining unit; and
a second flow passage defining unit to define a second flow passage by a surface of the second flow passage defining unit between the second electrode which is included in another power generation cell adjacent to the one power generation cell among the plurality of power generation cells and the second flow passage defining unit, wherein
the heating unit is provided at either one of the first flow passage defining unit or the second flow passage defining unit.

9. The fuel cell unit according to claim 8, wherein the heating unit is provided in either one of the first flow passage and the second flow passage.

10. The fuel cell unit according to claim 8, wherein the first flow passage defining unit also functions as the second flow passage defining unit, and the first flow passage divides the first material which flows through the first flow passage of the one power generation cell and the second material which flows through the second flow passage of the another power generation cell.

11. The fuel cell unit according to claim 1, wherein a radiation prevention unit to prevent radiation is provided at the power collection unit.

12. The fuel cell unit according to claim 6, wherein a radiation prevention unit to prevent radiation is provided at the flow passage defining unit.

13. The fuel cell unit according to claim 4, wherein a radiation prevention unit to prevent radiation is provided at the flow passage.

14. The fuel cell unit according to claim 6, wherein a radiation prevention unit to prevent radiation is provided at the flow passage.

15. The fuel cell unit according to claim 8, wherein a radiation prevention unit to prevent radiation is provided at either one of the first flow passage and the second flow passage.

16. The fuel cell unit according to claim 1, wherein
the first material is either one of an oxidant or a reductant, and
the second material is the other one of the oxidant or a reductant.

17. The fuel cell unit according to claim 19, further comprising a reformer to generate a reformed gas including hydrogen as the reductant by a reaction between a raw fuel and water.

18. The fuel cell unit according to claim 1, further comprising a heat insulation container to house the power generation cell therein.

19. An electronic device, comprising:
the fuel cell unit according to claim 1, and
an electronic device main body which operates by the power generated by the fuel cell unit.

20. An electronic device, comprising:
the fuel cell unit according to claim 6, and
an electronic device main body which operates by the power generated by the fuel cell unit.

21. An electronic device, comprising:
the fuel cell unit according to claim 8, and
an electronic device main body which operates by the power generated by the fuel cell unit.
